(19) United States
(12) Patent Application Publication
(10) Pub. No.: US 2010/0078113 A1
(43) Pub. Date: Apr. 1, 2010

(54) METHOD FOR DEPOSITING FILM AND FILM DEPOSITION APPARATUS

(75) Inventors: Tomokazu Sushihara, Matsudo-shi (JP); Nobutaka Ukigaya, Mobara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/568,672

(22) Filed: Sep. 29, 2009

(30) Foreign Application Priority Data
Sep. 30, 2008 (JP) 2008-251997
Sep. 8, 2009 (JP) 2009-207019

(51) Int. Cl. B32B 37/16

(52) U.S. Cl. 156/60; 156/349

(57) ABSTRACT

A method for depositing a film includes preparing a deposition material that is purified by sublimation, solidifying the purified deposition material in an environment having a reduced water content, conveying the solidified deposition material into a film deposition chamber through an environment having a reduced water content, and depositing a film of the solidified deposition material onto a substrate in the film deposition chamber.

### BACKGROUND OF THE INVENTION

1. Field of the Invention

The present invention relates to a method for depositing a film such as an organic film for an organic electroluminescent element (organic EL element), and a film deposition apparatus used for depositing such a film.

2. Description of the Related Art

Organic EL displays including organic EL elements emitting light of R (red), G (green), and B (blue) have an advantage of excellent light emission efficiency because color filters are not typically required. Light emitting layers for emitting color light in organic EL elements are generally formed as films in patterns. In general, a film is formed by a dry process such as mask deposition or laser transfer, or a wet process such as an inkjet method. Since organic EL elements can be susceptible to moisture, a dry process is mainly employed at present.

In recent years, organic EL elements having a higher light emission efficiency have been increasingly in demand. For this reason, when mask deposition is conducted, there may be a need to feed a high-purity organic material having a reduced water content to a film deposition apparatus, because water can be a cause of a decrease in light emission efficiency. However, there is a possibility that commercially available organic materials may be exposed to the air and absorb moisture after the materials have been purified by sublimation, and before the purified materials are fed to film deposition apparatuses. To deal with this problem, as disclosed in Japanese Patent Laid-Open No. 2006-131931, a film deposition method is proposed in which an organic material is not exposed to the air after the material has been purified by sublimation and before the purified material is fed to a film deposition apparatus, and a film of the material is deposited.

Japanese Patent Laid-Open No. 2006-131931 discloses a method in which a collecting member for collecting an organic material being sublimed for purification is used as a crucible and placed in a deposition apparatus, and film deposition is performed with the collecting member (i.e., crucible). This method can be very advantageous because the purified organic material is not exposed to the air, and hence detrimental effects such as contamination or absorption of moisture can be suppressed. However, since an organic material is collected in the sublimation-purification step by providing a temperature gradient, the resultant organic material in the collecting member (crucible) is in the form of powder, and has a low filling factor. Herein, a filling factor of a material can be represented by the following formula:

Filling factor of material=M/(V×ρ)×100

M: mass of material contained in crucible

V: volume of material in crucible

ρ: density of material

When an ordinary cylindrical crucible is used, volume V of a material in the crucible can be represented by the following formula:

V=S×H

S: area of interior side of base of crucible

H: distance from interior side of base of crucible to average height of material contained in crucible

When an organic material contained in a crucible has a low filling factor, the proportion of cavities in the crucible is typically high. Such cavities can inhibit uniform thermal conduction in the material, which causes problems in that it may take time to stabilize the film deposition, and the rate of film deposition may not stabilize.

### SUMMARY OF THE INVENTION

In one aspect of the invention, a method for depositing a film includes preparing a deposition material that is purified by sublimation, solidifying the purified deposition material in an environment having a reduced water content, conveying the solidified deposition material into a film deposition chamber through an environment having a reduced water content, and depositing a film of the solidified deposition material onto a substrate in the film deposition chamber.

In another aspect of the invention, a film deposition apparatus includes a film deposition chamber for depositing a film of a deposition material onto a substrate, a crucible for containing the deposition material that is purified by sublimation, and a pretreatment chamber for solidifying the deposition material contained in the crucible in an environment having a reduced water content. The film deposition apparatus also includes a conveying unit configured to convey the crucible from the pretreatment chamber to the film deposition chamber through an environment having a reduced water content.

Further features of the present invention will become apparent from the following description of exemplary embodiments with reference to the attached drawings.

### BRIEF DESCRIPTION OF THE DRAWINGS

FIG. 1 is an explanatory view for a step of pretreating a material in a film deposition apparatus in Example 1.

FIG. 2 is an explanatory view for a conveying step in a film deposition apparatus in Example 1.

FIG. 3 is an explanatory view for a film deposition step in a film deposition apparatus in Example 1.

FIG. 4 shows a film deposition apparatus in Example 2.

### DESCRIPTION OF THE EMBODIMENTS

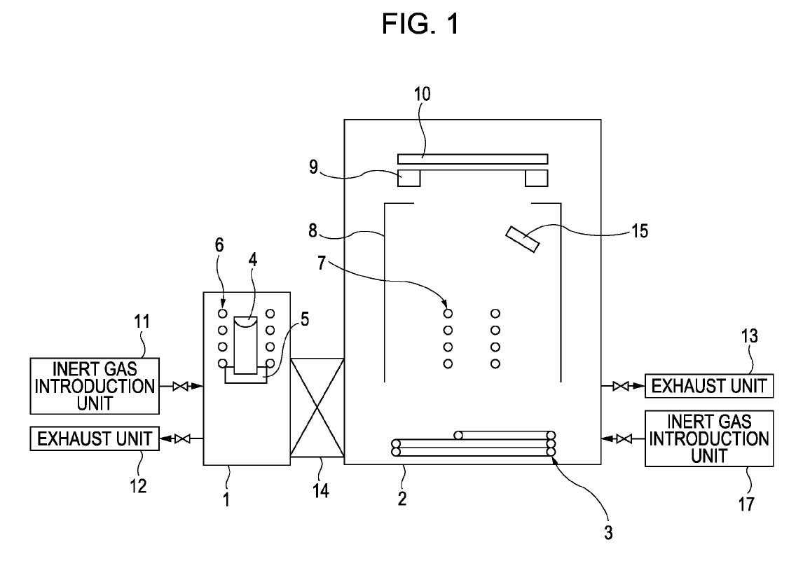

Embodiments according to aspects of the present invention will be described with reference to the drawings. First, an embodiment of a film deposition apparatus according to the present invention will be described. FIG. 1 shows an example of a film deposition apparatus according to the present invention. This film deposition apparatus includes a pretreatment chamber 1 in which a step of solidifying an organic material is conducted and a film deposition chamber 2 in which a step of depositing a film of the organic material is conducted. The pretreatment chamber 1 is in communication with the film deposition chamber 2 via a gate valve 14. The pretreatment chamber 1 contains a crucible holder 5 for holding a crucible 4, and a pretreatment heater 6 for heating the crucible 4. The pretreatment chamber 1 is further equipped with an inert gas introduction unit 11 and an exhaust unit 12. The exhaust unit 12 includes a pressure regulation device (not shown). By introducing an inert gas having a high purity into the pretreatment chamber 1 through the inert gas introduction unit 11, or by exhausting gas from the pretreatment chamber 1 with the exhaust unit 12, the pressure in the pretreatment chamber 1 can be freely regulated in a region of less than or equal to the atmospheric pressure and an environment having a reduced water content can be maintained in the pretreatment chamber 1. The film deposition chamber 2 contains a crucible conveying unit 3, a film deposition heater 7, a shielding plate 8, a mask 9, a support unit for supporting a wafer 10, and the like. As with the pretreatment chamber 1, the film deposition chamber 2 is further equipped with an inert gas introduction unit 17 and an exhaust unit 13 including a pressure regulation device (not shown). Thus, an environment having a reduced water content can also be maintained in the film deposition chamber 2.

The environment having a reduced water content refers to an environment having a dew point of −95° C. or less. Since the pressure of saturated aqueous vapor at a dew point of −95° C. is 6.0×10⁻³ Pa, exhausting gas from a chamber such that the chamber is at 6.0×10⁻³ Pa or less can provide an environment having a dew point of −95° C. or less. Alternatively, an environment having a dew point of −95° C. or less can also be provided by at least one of replacing the atmosphere of a chamber with a gas prepared to have a dew point of −95° C. or less, a high-purity inert gas having no water content, and the like.

Second, steps in an embodiment of a film deposition method according to the present invention will be described. The crucible 4 containing an organic material (i.e., deposition material), that has been purified by sublimation, is put into the pretreatment chamber 1 and held by the crucible holder 5. The crucible 4 being held by the crucible holder 5 is moved with a hoisting and lowering unit (not shown) to a position so as to be surrounded by the pretreatment heater 6. The pressure of the pretreatment chamber 1 is subsequently reduced to 6.0×10⁻³ Pa or less with the exhaust unit 12 to provide an environment having a reduced water content. Heating the crucible 4 with the pretreatment heater 6 under such an environment having a reduced water content can solidify the organic material in the crucible 4 to increase the filling factor of the material, and can also remove water from the material.

The term “solidifying” refers to a step of increasing the filling factor of an organic material in a crucible to 50% or more, by a method such as at least one of heating and application of pressure. Non-limiting examples of such a solidifying step are described below. A fusible organic material can be solidified by heating this material up to its melting point at a predetermined pressure in a reduced-pressure environment. An organic material that sublimes can be solidified by heating this material in the form of powder at a temperature lower than the boiling point of the material, and simultaneously compressing the material by an external physical pressure of 6.7 kPa or more.

After the organic material in the crucible 4 has been solidified, the crucible 4 is conveyed from the pretreatment chamber 1 to the film deposition chamber 2 by the crucible conveying unit 3. At this time, the pretreatment chamber 1 and the film deposition chamber 2 are controlled to have an environment having a reduced water content, and hence entry of water into the organic material in the crucible 4 can be minimized. While the crucible 4 is conveyed from the pretreatment chamber 1 to the film deposition chamber 2, the atmosphere of the pretreatment chamber 1 and the atmosphere of the film deposition chamber 2 may be respectively exhausted with the exhaust units 12 and 13 to 6.0×10⁻³ Pa or less.

The crucible 4 that has been conveyed to the film deposition chamber 2 is moved with a unit (not shown) to a position so as to be surrounded by the film deposition heater 7 and heated with the film deposition heater 7. A film of the organic material is deposited onto a substrate 10 while a deposition rate of the film is controlled by changing the temperature of the film deposition heater 7 with a PC (not shown) for controlling the thickness of a film on the basis of film-thickness data obtained with a film-thickness monitor 15.

The larger the amount of an organic material contained in the crucible 4 is, the longer the time over which film deposition can be performed becomes. For this reason, according to one aspect, the amount of an organic material contained in the crucible 4 may be increased by solidifying an organic material in the crucible 4, and subsequently adding an organic material that has been purified by sublimation into the crucible 4 and solidifying the resultant organic material in the crucible 4 again.

In summary, according to aspects of the film deposition method of the present embodiment, an organic material in a crucible is solidified in an environment having a reduced water content, the crucible is conveyed to a film deposition chamber through an environment having a reduced water content, and a film of the solidified organic material is deposited onto a substrate. Solidifying an organic material that has been purified by sublimation increases the filling factor of the organic material in a crucible, and can allow for stable film deposition.

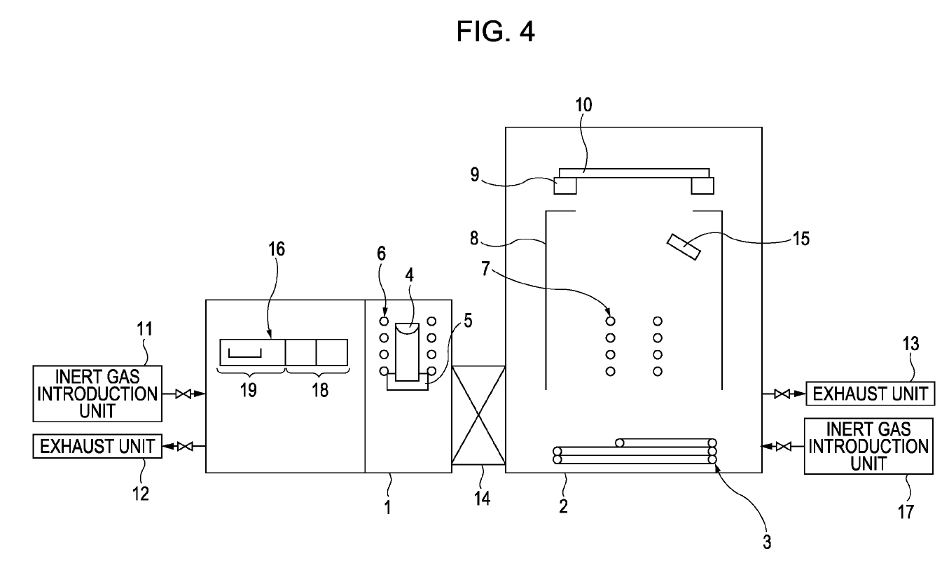

Entry of water into an organic material can be further reduced by conveying an organic material that has been purified by sublimation to a pretreatment chamber through an environment whose atmosphere has a reduced water content and solidifying the organic material in the pretreatment chamber. For example, referring to FIG. 4, an organic material may be purified by sublimation and solidified in an environment having a reduced water content with a sublimation-purification unit 16 installed in the pretreatment chamber 1, the environment being provided by exhausting the atmosphere of the chamber to 6.0×10⁻³ Pa or less with the exhaust unit 12.

The sublimation-purification unit 16 includes a heating area 19 for heating an organic material to be purified by sublimation, and a collecting area 18 in which temperature gradient is provided with a heater (not shown).

When an organic material to be purified by sublimation is heated, impurities having low sublimation temperatures, such as solvents used for the synthesis of the material, initially sublime and are collected in a low-temperature portion of the collecting area 18. As the temperature of the organic material gradually increases, an organic material containing few impurities starts to sublime and is collected in the collecting area 18. Impurities having high sublimation temperatures do not sublime and remain in the heating area 19. In this way, an organic material having a relatively high purity can be obtained.

FIG. 4 shows an example in which purification by sublimation and solidification are performed in one pretreatment chamber. Alternatively, this pretreatment chamber may be divided into a purification chamber in which purification by sublimation is performed and a treatment chamber in which solidification is performed. In this case, these two chambers can be connected to each other via a gate valve and each chamber can be equipped with an exhaust unit. Alternatively, the sublimation purification of the material may be performed with a purification apparatus including a sublimation-purification unit, the purification apparatus being separated from the film deposition apparatus. In this case, an organic material can be conveyed from the purification apparatus to the film deposition apparatus through an environment having a reduced water content. For example, an organic material may be enclosed in a container in an environment having a reduced water content, and the enclosed container may be conveyed from the sublimation-purification apparatus to the film deposition apparatus; or an organic material may be conveyed through a path under an environment having a reduced water content between the film deposition apparatus and the sublimation-purification apparatus. An organic material being sublimed may be collected into a crucible upon sublimation in the manner described in Japanese Patent Laid-Open No. 2006-131931. Alternatively, an organic material may be contained in a crucible after having been purified by sublimation.

### EXAMPLE 1

FIGS. 1 to 3 show a film deposition apparatus according to Example 1. Referring to FIG. 1, a crucible 4 containing an organic material having been purified by sublimation was prepared and held by a crucible holder 5 in a pretreatment chamber 1. Specifically, the crucible 4 was constituted by a titanium (Ti) cylinder, one end of which was covered with a bottom portion. A purified α-NPD powder serving as a material to be deposited was charged into the crucible 4 up to the top of the crucible 4 at a pressure of 5.0×10⁻³ Pa. The crucible 4 was then placed at a predetermined position in the pretreatment chamber 1. α-NPD is known as a fusible material.

After the pretreatment chamber 1 was evacuated to 1.0×10⁻³ Pa, the crucible holder 5 holding the crucible 4 was moved with a unit (not shown) to a position such that the crucible 4 was surrounded by a pretreatment heater 6. The crucible 4 was heated to 150° C. with the pretreatment heater 6 to thereby remove water in the organic material while the temperature of the crucible 4 was measured with a thermocouple (not shown). α-NPD starts to evaporate at about 300° C. in a vacuum on the order of 1×10⁻³ Pa and does not evaporate at 150° C.

To increase the filling factor of the organic material (α-NPD) in the crucible 4, the α-NPD in the crucible 4 was heated to 280° C. Since the melting point of α-NPD is 280° C. to 285° C., heating to this temperature range melts α-NPD but does not cause α-NPD to evaporate. After the temperature of the α-NPD in the crucible 4 was maintained at 280° C. for 30 minutes, the crucible 4 was cooled and the organic material in the crucible 4 was solidified. This solidification reduced the volume of the organic material that was initially charged into the crucible 4 up to the top of the crucible 4 and the filling factor of the material increased. The filling factor of the α-NPD prior to the solidification was about 30% and the solidification increased the filling factor to about 50%. Such an increase in a filling factor varies depending on an organic material solidified.

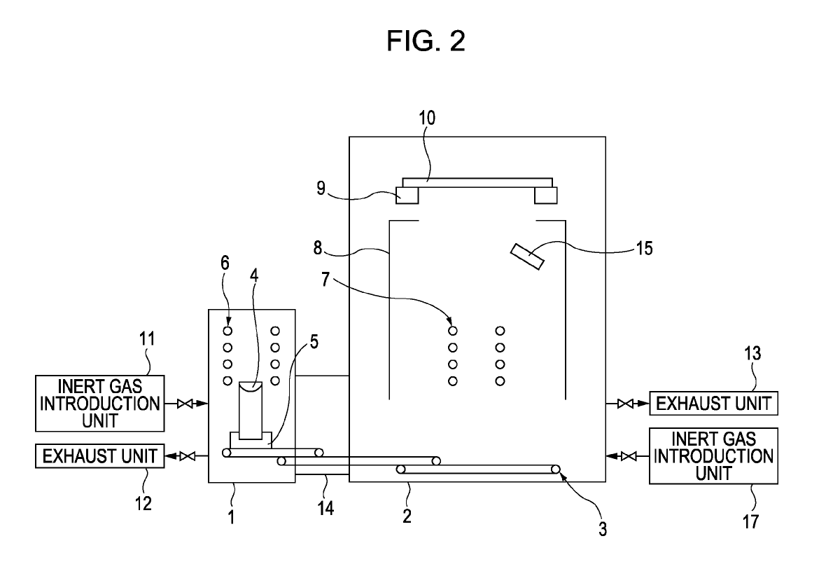

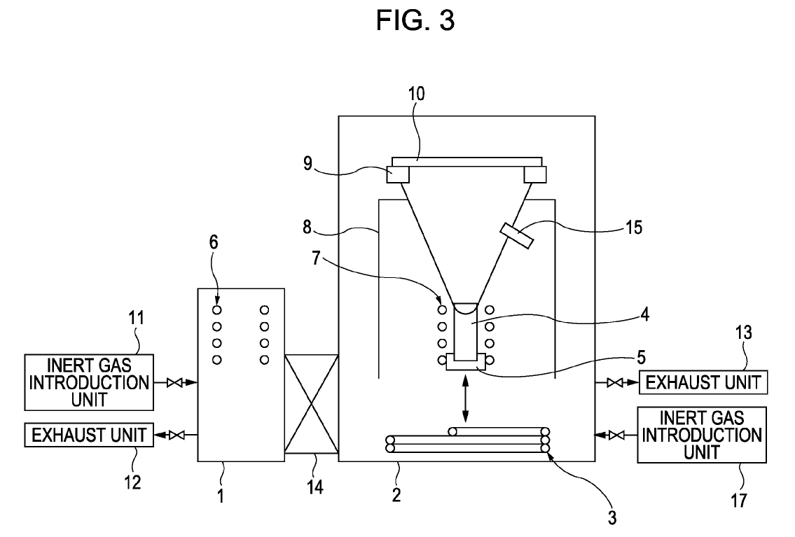

Referring to FIG. 2, the crucible 4 was subsequently moved onto a crucible conveying unit 3. At this time, the pressure of the pretreatment chamber 1 and the film deposition chamber 2 was reduced to 1.0×10⁻³ Pa, to thereby provide an environment having a dew point of −95° C. or less. Keeping a general organic material in an environment having a dew point of −95° C. or less can provide sufficiently good device characteristics. Controlling an environment to be at a dew point of −95° C. or less can also provide equivalent advantage in an inert gas atmosphere. Referring to FIG. 3, the crucible 4 was conveyed into the film deposition chamber 2 by the crucible conveying unit 3 and moved by a unit (not shown) to a position so as to be surrounded by a film deposition heater 7.

The crucible 4 was heated by the film deposition heater 7 and a film of the organic material was deposited onto a substrate 10 at about 300° C., which is the evaporating temperature of the organic material, while the evaporation rate of the organic material was controlled on the basis of film-thickness data obtained with a film-thickness monitor 15.

In this way, the film deposition was continuously performed for 48 hours. The evaporation rate during this film deposition was within ±5% and extremely stable except peaks probably due to electrical noise of the film-thickness monitor 15. Thus, it has been confirmed that film deposition can be stably performed for 48 hours. Variation in the rate or pressure upon evaporation of the material probably due to cavities in the crucible was not observed.

According to Example 1, conducting the step of solidifying an organic material and the step of conveying the organic material into a film deposition chamber through an environment having a reduced water content can increase the filling factor of the organic material in the crucible 4 and can minimize entry of water into the organic material. As a result, organic EL elements can be stably manufactured.

### EXAMPLE 2

Referring to FIG. 4, film deposition was conducted with the film deposition apparatus according to the drawing. First, the step of purifying a material (organic material) by sublimation to provide a deposition material and the step of solidifying the deposition material were conducted in the same environment having a reduced water content at 1.0×10⁻³ Pa.

Specifically, the organic material to be purified by sublimation was fed to a heating area 19 in the left portion of a sublimation-purification unit 16. The right portion of the sublimation-purification unit 16 included a collecting area 18 in which a temperature gradient was provided and a sublimed material was collected. Since α-NPD (organic material) has a melting point of 280° C. to 285° C., the temperature gradient in the major subarea of the collecting area 18 was set so as to range from 250° C. to 300° C. The collecting area 18 also included a subarea that was water-cooled to 20° C., the subarea being positioned at the farthest from the heating area 19. The temperature gradient in the collecting area 18 was optimized by adjusting the number of turns of a heater. After the collecting area 18 reached a predetermined temperature, heating of the organic material in the heating area 19 was started. The temperature of the heating area 19 was controlled such that the temperature was ramped to 200° C. at a rate of 1° C./minute, from 200° C. to 300° C. at a rate of 0.5° C./minute, and was maintained at 300° C. Impurities having low sublimation temperatures were collected in the water-cooled subarea (20° C.) of the collecting area 18. Impurities having high sublimation temperatures remained in the heating area 19. A material collected in the region of 250° C. to 300° C. of the collecting area 18 was used as the deposition material.

This deposition material (purified organic material) was charged into a crucible 4. The crucible 4 was conveyed by a unit (not shown) in a pretreatment chamber 1 through an environment having a reduced water content. The atmosphere in this environment was at a reduced pressure of 1.0×10⁻³ Pa and at a dew point of −95° C. or less. Keeping a general organic material in an environment having a dew point of −95° C. or less can provide sufficiently good device characteristics. Controlling an environment to be at a dew point of −95° C. or less can also provide equivalent advantage in an inert gas atmosphere.

Solidification of the organic material was subsequently conducted in the same manner as in Example 1. The crucible 4 containing the organic material purified by sublimation was held by a crucible holder 5 in the pretreatment chamber 1. The pretreatment chamber 1 was evacuated to 1.0×10⁻³ Pa or less with an exhaust unit 12.

After the pretreatment chamber 1 was thus made to be at the reduced pressure, the crucible holder 5 holding the crucible 4 was moved with a unit (not shown) to a position such that the crucible 4 was surrounded by a pretreatment heater 6. The crucible 4 was heated with the pretreatment heater 6. In Example 2, since the sublimation-purification step and the solidification step were conducted in the same environment in which the atmosphere had a reduced water content, the organic material did not absorb moisture from the air. For this reason, the heating at 150° C. for removing water in the organic material prior to the solidification step was not conducted.

The following steps were conducted in the same manner as in Example 1. After the organic material was solidified in the crucible 4, the crucible 4 was conveyed into the film deposition chamber 2 through an environment having a reduced water content, and film deposition was performed in the film deposition chamber 2.

In this way, the film deposition was continuously performed for 48 hours. The evaporation rate during this film deposition was within ±3% and extremely stable except peaks probably due to electrical noise of a film-thickness monitor 15. Thus, it has been confirmed that film deposition can be stably performed for 48 hours. Variation in the rate or pressure upon evaporation of the material probably due to cavities in the crucible was not observed.

In Example 2, the sublimation-purification step, the step of solidifying the organic material, and the film deposition step were performed in the same environment having a reduced water content, to thereby increase the filling factor of the organic material in the crucible 4. As a result, entry of impurities into the organic material was minimized and the stability of film deposition was extremely enhanced.

According to the examples, it is shown that solidifying an organic material in an environment having a reduced water content prior to the film deposition step, the organic material having been purified by sublimation, can increase the filling factor of the organic material in the crucible and can also reduce the water content of the material. Additionally, conveying the solidified organic material into the film deposition chamber through an environment having a reduced water content can suppress entry of water into the organic material. As a result, organic EL elements can be stably manufactured.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-251997 filed Sep. 30, 2008 and No. 2009-207019 filed Sep. 8, 2009, which are hereby incorporated by reference herein in their entirety.

What is claimed is:

1. A method for depositing a film comprising:
preparing a deposition material that is purified by sublimation;
solidifying the purified deposition material in an environment having a reduced water content;
conveying the solidified deposition material into a film deposition chamber through an environment having a reduced water content; and
depositing a film of the solidified deposition material onto a substrate in the film deposition chamber.

2. The method according to claim 1, wherein the environment has a dew point of −95° C. or less.

3. The method according to claim 1, wherein a pressure of the environment is 6.0×10⁻³ Pa or less.

4. A film deposition apparatus comprising:
a film deposition chamber for depositing a film of a deposition material onto a substrate;
a crucible for containing the deposition material that is purified by sublimation;
a pretreatment chamber for solidifying the deposition material contained in the crucible in an environment having a reduced water content; and
a conveying unit configured to convey the crucible from the pretreatment chamber to the film deposition chamber through an environment having a reduced water content.

5. The film deposition apparatus according to claim 4, further comprising a sublimation-purification unit configured to purify a material by sublimation in an environment having a reduced water content to provide the deposition material purified by sublimation.

6. A method for manufacturing a film comprising an organic material comprising:
purifying the organic material by sublimation in an environment having a pressure of 6.0×10⁻³ Pa or less;
solidifying the purified organic material in an environment having a pressure of 6.0×10⁻³ Pa or less;
conveying the solidified organic material into a chamber in an environment having a pressure of 6.0×10⁻³ Pa or less; and
forming the film comprising the organic material on a substrate by heating the solidified organic material in an environment having a pressure of 6.0×10⁻³ Pa or less.
